(19) United States
(12) Patent Application Publication
(10) Pub. No.: US 2024/0385334 A1
(43) Pub. Date: Nov. 21, 2024

(54) OPTICAL METHOD FOR MEASURING ABSORBED DOSE AND OPTICAL DEVICE FOR MEASURING ABSORBED DOSE

(71) Applicant: COMMISSARIAT A L'ENERGIE ATOMIQUE ET AUX ENERGIES ALTERNATIVES, Paris (FR)

(72) Inventors: Alice ROUSSEAU, Gif-sur-Yvette (FR); Christel STIEN, Gif-sur-Yvette (FR)

(73) Assignee: COMMISSARIAT A L'ENERGIE ATOMIQUE ET AUX ENERGIES ALTERNATIVES, Paris (FR)

(21) Appl. No.: 18/570,103

(22) PCT Filed: Jun. 3, 2022
(86) PCT No.: PCT/FR2022/051068

§ 371 Date: Dec. 14, 2023

(30) Foreign Application Priority Data
Jun. 15, 2021 (FR) FR21 06338

(51) Int. Cl. G01T 1/04; G01T 1/161

(52) U.S. Cl. CPC G01T 1/04; G01T 1/161

(57) ABSTRACT

An optical device and an optical method for measuring dose absorbed by a radiochromic material, the method including successively submitting the radiochromic material to a first electromagnetic measurement emission at a first wavelength and to a second electromagnetic measurement emission at a second wavelength, and measuring first and second measurement signals corresponding to the parts of the first and second electromagnetic measurement emissions not absorbed by the radiochromic material, respectively. The measured absorbed-dose value is determined, in the case where the first or second measurement signal corresponds to an absorption higher than a given threshold, on the basis of the second signal and, in the contrary case, on the basis of the first signal.

### TECHNICAL FIELD

The invention relates to the field of ionising radiation dosimetry by reading radiochromic materials.

Thus, more specifically the object of the invention is an optical method for measuring absorbed dose based on radiochromic materials and an optical device for measuring absorbed dose based on radiochromic materials.

### PRIOR ART

In order to make treatments performed on the basis of radiotherapy equipment safer, it is possible to check the correct adjustment of this equipment by simulating a radiotherapy treatment on a phantom wherein a vial has been placed containing a radiochromic material, such as a radiochromic gel, simulating the tumour and its environment. Once the simulated treatment has been performed, the correct implementation of this treatment is checked by a dosimetric measurement on the vial in order to know the spatial distribution of the absorbed dose.

It will be noted that a phantom is, in radiotherapy, a model simulating a representation of a human body portion whereon the treatment must be targeted. Such a phantom may be made of one or more materials equivalent to the tissue of said human body portion. Within the scope of the invention, such a phantom may have a cavity for housing the vial of radiochromic material.

Dosimetric measurements on the basis of these radiochromic materials may be performed in various ways, of which the optical absorption measurements, such as optical tomography, which are easy to implement and for which the affordability of optical measurement devices is greater. Such absorption measurements may be performed on materials, such as gels, known as radiochromic, and are based on the fact that the irradiation induces reactions in these materials of which the reaction products absorb at certain wavelengths, particularly in the visible range. Thus, by measuring the absorption rate of the radiochromic material at a wavelength corresponding to an absorption peak of the product formed under irradiation, it is possible to accurately trace back, thanks to a preliminary calibration, to the ionising radiation dose that was absorbed by the radiochromic material, hereinafter absorbed dose.

Here, absorbed dose means, in the remainder of this document and in conformity with the understanding of the person skilled in the art, the energy per unit of mass deposited by the ionising radiation, here in the radiation sensitive material. Such an absorbed dose is generally expressed in Gray (Gy).

Nevertheless, the use of such optical measurement devices has a certain number of drawbacks particularly as regards their high sensitivity in relation to the absorbed dose deposited in the radiochromic material. Indeed, by taking the example of Fricke-Xylenol orange-Gelatin, which functions on the principle of Fe(III) ion complexation with a colourant under the effect of the irradiation, the dosimetric measurements must make it possible to accurately know the absorbed doses deposited both at the area treated (that simulating the tumour), that may reach up to absorbed-dose values in the order of 10 Gy, or even higher, for stereotactic radiotherapy, and within the vicinity of this area (simulating a healthy area), ideally lower than 1 Gy. Yet, if the current optical devices for measuring absorbed dose are adapted to measure the low absorbed doses (that is to say lower than 3 Gy for the Fricke-Xylenol orange Gelatin for example), the optical absorption measurements generally have a plateau above this value, related to the contrast differences between the radiochromic material and the solution wherein the vial is plunged during its reading, and it is therefore not possible to discriminate the doses higher than 3 Gy.

Therefore, in order to obtain an accurate measurement of the absorbed dose deposited in the radiochromic material, it is necessary to reduce the dose applied within the scope of simulating the radiotherapy treatment and therefore to reduce the representativeness of this treatment in relation to that which will be applied to the patient. The risks inherent to such a solution are, if possible, to be avoided.

In order to remedy these drawbacks, it was proposed in various studies, of which particularly that by K. Jordan and J. Battista published in the scientific journal “Journal of Physics: Conference Series” no. 164 pages 012045, to modify the composition of the solution wherein the vial of radiochromic material is plunged during its reading in order to increase the absorption of the latter and thus reduce the contrast differences between the radiochromic material and the solution. Nevertheless, the various solutions proposed are not really suitable. Indeed, the additives proposed have the drawback of having an absorption that varies over time and may cause the formation of algae or of mould.

Therefore, there is currently no optical method for measuring distribution of doses on the basis of radiochromic materials, particularly within the scope of 3D optical tomography, which makes it possible to supply reliable measurements for relatively high absorbed doses (for example higher than 3 Gy if the example of Fricke-Xylenol orange Gelatins is taken).

### DISCLOSURE OF THE INVENTION

The aim of the invention is to remedy this drawback and therefore the object of the invention is to supply an optical method for measuring absorbed dose that permits, on the basis of radiochromic materials, to expand thereby the range of discriminable absorbed doses.

To this end, the invention relates to an optical method for measuring dose absorbed by a radiochromic material to be measured implemented by means of an optical device for measuring absorbed dose comprising at least one optical source capable of emitting an electromagnetic emission and at least one optical detector capable of detecting the electromagnetic emission emitted by the at least one optical source, the radiochromic material to be measured having a varying optical absorption depending on the absorbed dose and the radiochromic material to be measured having been previously irradiated, the method comprising the following steps of:
emitting, by the at least one optical source, a first electromagnetic measurement emission at a first wavelength in the direction of the radiochromic material to be measured,
measuring by the optical detector first measurement signals representative of the part of the first electromagnetic measurement emission not absorbed by the radiochromic material to be measured,
determining at least one measured absorbed-dose value of said radiochromic material to be measured,
the measurement method furthermore comprising the following steps of:
emitting, by the at least one optical source, a second electromagnetic measurement emission at a second wavelength in the direction of the radiochromic material to be measured, the second wavelength being selected to have, for a given absorbed dose, an absorption rate of the radiochromic material to be measured lower than the absorption rate of the radiochromic material to be measured at the first wavelength,
measuring by the optical detector second measurement signals representative of the part of the second electromagnetic measurement emission not absorbed by the radiochromic material to be measured,
wherein, during the step of determining at least one measured absorbed-dose value, the following sub-steps are provided of:
   for the or each measured absorbed-dose value to be determined, checking at least one condition from:
      the first signal associated with said absorbed dose to be determined corresponds to an absorption of the first electromagnetic emission higher than or equal to, or even strictly higher than, a first threshold; and
      the second signal associated with said absorbed dose to be determined corresponds to an absorption of the second electromagnetic emission higher than or equal to, or even strictly higher than, a second given threshold equivalent to said first threshold;
   for the or each measured absorbed-dose value to be determined, in the case where said at least one condition is met, determining said measured absorbed-dose value on the basis of the second signal, said measured absorbed-dose value being determined on the basis of the first signal in the case where the at least one condition is not met.

Such a method for measuring at two wavelengths makes it possible to obtain an accurate measurement of dose absorbed by the radiochromic material over an absorbed-dose range wider than in the case of the use of a single measurement wavelength. Indeed, with such a method:
for the locations in the radiochromic material such as those corresponding to the simulated tumour, having been subjected to a high absorbed dose that would not be able to be discriminated with a method of the prior art, the absorbed doses are determined on the basis of the second signal, making it possible to maintain a good sensitivity for the optical detector,
whereas for the locations such as those corresponding to the vicinity of the simulated tumour, having been subjected to a relatively low absorbed dose, the absorbed doses are determined on the basis of the first signal, making it possible to maintain a good sensitivity obtained by the methods of the prior art.

Thus, with such a method, it is possible to obtain a good absorbed dose sensitivity, this for a range of absorbed doses greater than that offered by the methods of the prior art. In addition, it will be noted that this good sensitivity may be obtained with a conventional composition of the solution wherein the vial of radiochromic material is plunged and which is therefore not subjected to ageing problems such as those encountered by K. Jordan and J. Battista within the scope of the aforementioned works.

It will be noted that within the scope of a conventional measurement of dose absorbed by radiochromic material, such as those performed by a 3D optical tomography, it is determined, on the basis of a plurality of absorbed dose measurements, a mapping of doses absorbed by the radiochromic material. This mapping may be a 2D, or even 3D, image of the absorbed dose delivered in the radiochromic material.

The at least one optical source may comprise a first optical source capable of emitting the first electromagnetic measurement emission and a second optical source capable of emitting the second electromagnetic measurement emission, the first optical source being implemented during the step of emitting the first electromagnetic measurement emission and the second optical source being implemented during the step of emitting the second electromagnetic measurement emission.

The first wavelength may be associated with an absorption peak of the irradiated radiochromic material, and the second wavelength being selected in such a way that, for a given absorbed dose, the radiochromic material having at the second wavelength an absorption rate lower than two times, or even four times, the absorption rate presented at the first wavelength.

In this way, the range of discriminable absorbed doses is particularly extensive.

The radiochromic material may be a dosimetric gel comprising xylenol orange, the first wavelength being in a first range of wavelengths ranging from 550 to 600 nm, or even from 570 to 590 nm, and the second wavelength being in a range of wavelengths ranging from 620 to 645 nm, or even from 625 to 640 nm.

The first threshold and/or the second threshold corresponds to an absorption of the first and/or second electromagnetic emission obtained for an absorbed dose between 2.5 Gy and 4.5 Gy, preferably between 3 and 4 Gy.

Thus, the method makes it possible to cover a range of absorbed doses extending from 0.25 Gy to 10 Gy that is particularly adapted for stereotactic radiotherapy.

The measurement method may comprise a preliminary step of determining the second wavelength comprising the following sub-steps of:
defining a maximum expected absorbed-dose value, a minimum value to be discriminated of absorbed dose and of the first wavelength, the first wavelength being associated with an absorption peak of the radiochromic material to be measured after irradiation,
supplying at least one first etalon having areas representative of the expected absorption of the radiochromic material for a plurality of respective doses absorbed in a range of absorbed doses ranging from at least the minimum value to be discriminated to at least the maximum expected value,
measuring, for each area of the at least one first etalon, absorption spectra over a range of wavelengths including the absorption peak of the radiochromic material to be measured after irradiation with which the first wavelength is associated,
on the basis of the absorption spectra measured, identifying for the area corresponding to the dose value higher than or equal to the maximum dose value, the second wavelength for which the absorption is discriminable with the optical detector,
on the basis of the absorption spectra measured and the areas of the at least one etalon, identifying a transition absorbed-dose value between the first and the second wavelength for determining the absorbed-dose value to be measured,
defining, on the basis of the transition absorbed-dose value identified and possibly the absorption spectra measured, a threshold from a first threshold corresponding to an absorption of the first electromagnetic measurement emission at said transition absorbed-dose value identified, and a second threshold corresponding to an absorption of the second electromagnetic measurement emission at said transition absorbed-dose value identified.

In this way, it is possible to accurately adapt the second wavelength to the maximum expected absorbed dose.

The method may furthermore comprise a preliminary calibration step, the preliminary calibration step comprising the following sub-steps of:
supplying at least one second etalon having areas representative of the expected absorption of the radiochromic material for a plurality of doses absorbed in a range of absorbed doses including an absorbed dose corresponding to the first or second threshold,
emitting, by the at least one optical source, a first calibration electromagnetic emission at the first wavelength in the direction of the at least one second etalon,
measuring, by the optical detector and for at least two areas of the at least one second etalon corresponding to two different absorbed doses lower than or equal to the absorbed dose corresponding to the first or second threshold, first calibration signals representative of the part of the first calibration electromagnetic emission not absorbed by the at least one second etalon,
calculating, on the basis of the first calibration signals and for the first wavelength, a first determination relation to be used to determine the measured absorbed-dose value in said radiochromic material to be measured when the condition is not met,
emitting, by the at least one optical source, a second calibration electromagnetic emission at the second wavelength in the direction of the at least one second etalon,
measuring, by the optical detector and for at least two areas of the at least one second etalon corresponding to two different absorbed doses higher than or equal to the absorbed dose corresponding to the first or second threshold, second calibration signals representative of the part of the second calibration electromagnetic emission not absorbed by the at least one second etalon,
calculating, on the basis of the second calibration signals and for the second wavelength, a second determination relation to be used to determine the measured absorbed-dose value in said radiochromic material to be measured when the condition is met.

Such a preliminary calibration step makes it possible to ensure an accurate measurement of the measured absorbed-dose value this both for the high absorbed doses, that is to say on the basis of the second measurement signals, and for the low absorbed doses, that is to say on the basis of the first measurement signals.

Furthermore, the invention relates to an optical device for measuring dose absorbed by a radiochromic material to be measured, the radiochromic material to be measured having a varying optical absorption depending on the absorbed dose, comprising:
at least one optical source capable of emitting a first electromagnetic measurement emission at a first wavelength in the direction of the radiochromic material to be measured,
at least one optical detector capable of detecting the first electromagnetic measurement emission emitted by the at least one optical source and more specifically of measuring the first measurement signals representative of a part of the first electromagnetic measurement emission not absorbed by the radiochromic material to be measured,
a calculation unit configured to determine at least one measured absorbed-dose value received by the radiochromic material to be measured,
the at least one optical source being capable of emitting a second electromagnetic measurement emission at a second wavelength, the second wavelength having, for the same given absorbed dose, an absorption rate of the radiochromic material to be measured lower than the absorption rate of the radiochromic material at the first wavelength,
the at least one optical detector being capable of measuring second measurement signals representative of a part of the second electromagnetic measurement emission not absorbed by the radiochromic material to be measured,
the calculation unit being configured to, during the determination of the at least one measured absorbed-dose value:
   for the or each measured absorbed-dose value to be determined, check at least one condition from:
      the first measurement signal associated with said absorbed dose corresponds to an absorption of the first electromagnetic measurement emission higher than or equal to, or even strictly higher than, a first threshold; and
      the second measurement signal associated with said absorbed dose corresponds to an absorption of the second electromagnetic measurement emission higher than or equal to, or even strictly higher than, a second given threshold equivalent to said first threshold;
   for the or each measured absorbed-dose value to be determined, in the case where said at least one condition is met, determine said measured absorbed-dose value on the basis of the second measurement signal, the calculation unit determining said measured absorbed-dose value on the basis of the first measurement signal in the case where said at least one condition is not met.

Such a device makes it possible to implement a method according to the invention and therefore to benefit from advantages pertaining to such a method.

The at least one optical source may comprise a first optical source capable of emitting the first electromagnetic measurement emission and a second optical source capable of emitting the second electromagnetic measurement emission.

The radiochromic material to be measured may be a dosimetric gel comprising xylenol orange, the first wavelength being between a first range of wavelengths ranging from 550 to 600 nm, or even from 570 to 590 nm, and the second wavelength being in a range of wavelengths ranging from 620 to 645 nm, or even from 625 to 640 nm.

### BRIEF DESCRIPTION OF THE DRAWINGS

The present invention will be better understood upon reading the description of embodiment examples, given purely by way of indicative and non-limiting example, while referring to the appended drawings wherein:

FIG. 1 illustrates the irradiation of the radiochromic material by an ionising radiation beam within the scope of a simulation of a radiotherapy treatment, the radiochromic material being arranged in a phantom simulating a head of a patient to be treated,

FIG. 2 illustrates a measurement device according to the invention within the scope of an optical measurement of absorbed dose according to the invention,

FIG. 3 illustrates an example of evolution of the absorbance spectrum depending on the absorbed dose in the case of a Fricke-Xylenol orange-Gelatin as radiochromic material,

FIG. 4A illustrates a calibration curve of the absorbance at a first wavelength obtained for this same Fricke-Xylenol orange-Gelatin depending on the absorbed dose,

FIG. 4B illustrates a calibration curve of the absorbance at a second wavelength obtained for this same Fricke-Xylenol orange-Gelatin depending on the absorbed dose,

FIG. 5A illustrates a first and a second absorbed-dose measurement performed respectively at the first and at the second wavelength of the Fricke-Xylenol orange-Gelatin irradiated beforehand with an absorbed dose of 9 Gy, and

FIG. 5B illustrates an absorbed-dose measurement obtained by a combination of the first and of the second measurement according to the principle of the invention.

Identical, similar or equivalent parts of the various figures bear the same numerical references so as to facilitate the transition from one figure to the other.

The various parts shown in the figures are not necessarily according to a uniform scale, in order to make the figures more readable.

The different options (alternative embodiments and embodiments) should be understood as not being mutually exclusive and can be combined with one another.

### DESCRIPTION OF THE EMBODIMENTS

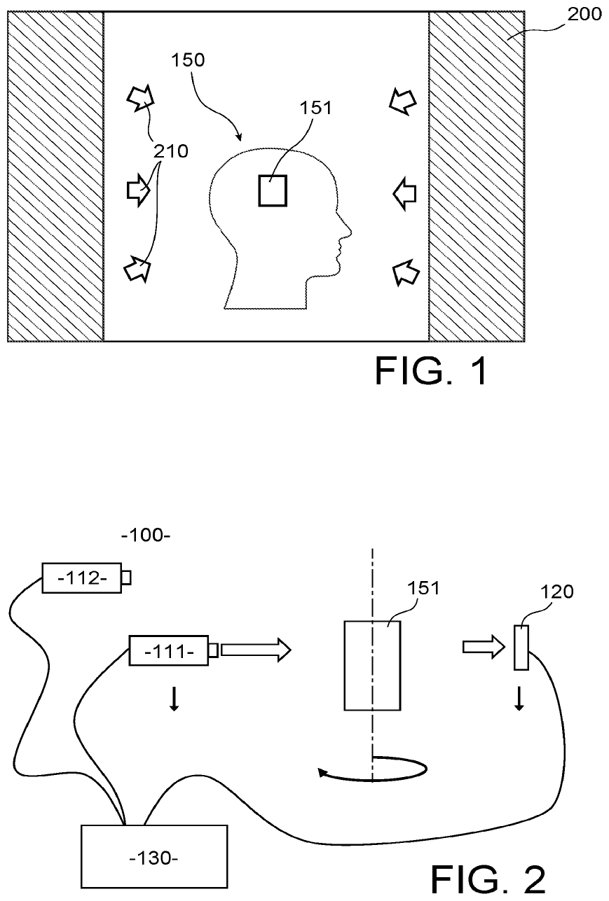

FIGS. 1 and 2 illustrate respectively and schematically a radiotherapy system 200 during the submission of a phantom 150, wherein a radiochromic material 151 is deposited, with a radiotherapy treatment the ionising radiation of which is referenced 210, and an optical device for measuring 100 absorbed dose within the scope of the dosimetric measurement of said radiochromic material 151. Such an optical measurement device 100 is particularly adapted, as shown hereinafter, to measure relatively high absorbed doses, for example in the order of 10 Gy.

It will be noted that an optical device for measuring absorbed dose 100 according to the invention is in particular adapted to measure a spatial distribution of the absorbed dose in the radiochromic material, this spatial distribution being able to be for example a 2D mapping or also a 3D mapping, such as obtained by optical tomography, of the absorbed dose.

As shown in FIG. 1, within the scope of a conventional dosimetry measurement, as this is also the case within the scope of the invention, prior to administering radiotherapy treatment to a patient and in order to check the correct adjustment of the radiotherapy equipment 200, the phantom 150 is subjected to a treatment identical to that which will be applied to the patient in order to simulate the latter.

Once this radiotherapy treatment simulation has been performed on the phantom 150, and therefore on the vial of radiochromic material 151 that it contains, according to the principle of the invention, an optical dosimetry measurement is performed in order to check the spatial distribution of the absorbed dose in the radiochromic material 151.

FIG. 2 illustrates the optical device for measuring absorbed dose 100 that may be implemented within the scope of such an optical dosimetry measurement. Such an optical device for measuring absorbed dose 100 comprises:
a first optical source 111 capable of emitting a first electromagnetic measurement emission at a first wavelength in the direction of the radiochromic material 151 to be measured,
a second optical source 112 capable of emitting a second electromagnetic measurement emission at a second wavelength in the direction of the radiochromic material 151 to be measured,
an optical detector 120 capable of detecting the electromagnetic measurement emissions emitted by the first and second optical sources 111, 112 and more specifically of measuring the first measurement signals representative of a part of the first electromagnetic measurement emission not absorbed by the radiochromic material 151 to be measured and the second signals representative of a part of the second electromagnetic measurement emission not absorbed by the radiochromic material 151 to be measured,
a calculation unit 130 configured to determine at least one measured absorbed-dose value in the radiochromic material 151 to be measured.

It will be noted that with such a configuration with a first and second optical source 111, 112, the optical measurement device comprises at least one optical source 111, 112 since it includes said first and second optical sources 111, 112. Of course, it is possible, without departing from the scope of the invention, that the optical device for measuring absorbed dose 100 comprises a single optical source, the latter, for example, having to be tunable or filtered in wavelength, in order to permit the emission of the first and second electromagnetic measurement emission.

In such a device, the calculation unit is furthermore configured to, during the determination of at least one measured absorbed-dose value:
for the or each measured absorbed-dose value to be determined, check at least one condition from:
   the first measurement signal associated with said dose corresponds to an absorption of the first electromagnetic measurement emission higher than or equal to, or even strictly higher than, a first threshold; and
   the second measurement signal associated with said dose corresponds to an absorption of the second electromagnetic measurement emission higher than or equal to, or even strictly higher than, a second given threshold equivalent to said first threshold;
for the or each measured absorbed-dose value to be determined, in the case where said at least one condition is met, determine said measured absorbed-dose value on the basis of the second measurement signal, the calculation unit 130 determining said measured absorbed-dose value on the basis of the first measurement signal in the case where said at least one condition is not met.

In the present embodiment of the invention, the radiochromic material 151 selected is a dosimetric gel comprising xylenol orange, Fricke-Xylenol orange-Gelatin. This radiochromic material has the specific feature of forming under irradiation a xylenol orange-Iron (III) complex including an absorption peak at 585 nm.

The first wavelength is preferably a wavelength associated with an absorption peak of the irradiated radiochromic material, that is to say close to this last peak, and the second wavelength is selected so as to have, for a given absorbed dose, an absorption rate lower than two times, or even four times, the absorption rate presented by the radiochromic material at the first wavelength for this same absorbed dose.

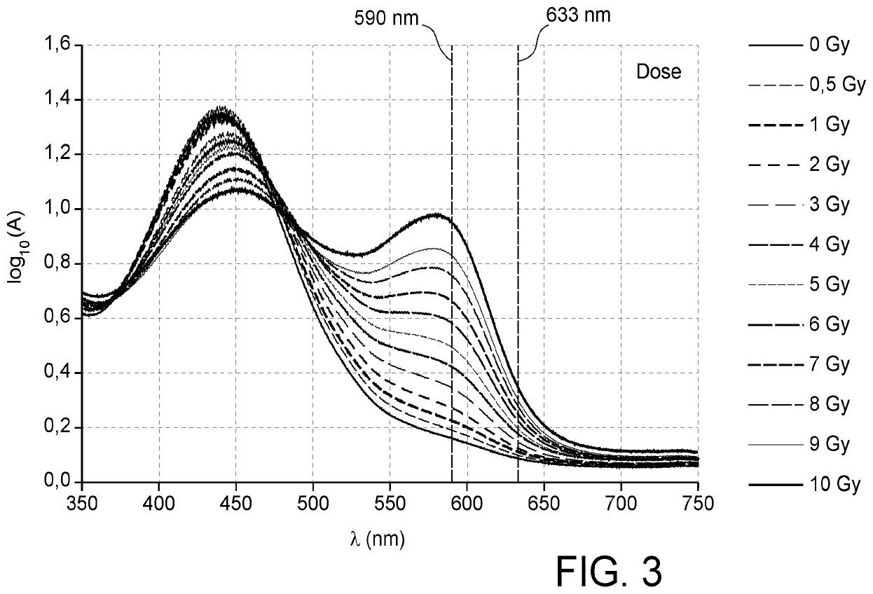

Thus, according to the principle of the invention, and based on radiotherapy treatments at relatively high doses up to 10 Gy, such as achievable in stereotactic radiotherapy, the second wavelength may be adapted to such absorbed-dose values. For this, the inventors identified that it was possible to use for a Fricke-Xylenol orange-Gelatin with the following reading parameters:
a first wavelength in a first range of wavelengths ranging from 550 to 600 nm, or even from 570 to 590 nm, that is to say close to the absorption peak, and
a second wavelength in a range of wavelengths ranging from 620 to 645 nm, or even from 625 to 640 nm, offering, as will be shown in connection with FIGS. 3, 4B and 5A a good sensitivity for the absorbed doses ranging up to 10 Gy.

Thus, within the scope of the present embodiment, the first wavelength is set at 590 nm and the second wavelength is set at 633 nm. The first and second optical sources 111, 112 are thus two sets of LEDs, pass-band filters and diffuser blocks emitting respectively to said first and second wavelengths. Alternatively, at least one of the first and second optical source 111, 112 may be supplied by a substantially monochromic electromagnetic diode; or even a laser diode or also a polychromatic source associated with a monochromator or a system of wavelength filters.

Of course, if these values of first and second wavelengths are adapted for a Fricke-Xylenol orange-Gelatin, other values of first and second wavelengths may be adapted to the use of other types of radiochromic materials without departing from the scope of the invention. Thus, alternatively to a radiochromic material comprising xylenol orange, the radiochromic material 151 may comprise one of methylthymol blue, leucomalachite green and Turnbull's blue or also be a commercial radiochromic gel such as the gel marketed under the name “ClearView™”. For example, if the radiochromic material 151 comprises leucomalachite green, the first wavelength may be close to 630 nm, whereas if the radiochromic material comprises Turnbull's blue, the first wavelength may be close to 690 nm.

The optical detector 120 may be a CCD sensor adapted to measure the intensity of the first and of the second electromagnetic measurement emission not absorbed by the radiochromic material 151. As a variant, the optical detector 120 may include another type of photodetector, such as a CMOS sensor, one or more photodiodes or photomultipliers (arranged or not in a matrix), without departing from the scope of the invention.

The calculation unit 130 may be supplied by dedicated electronics, a sub-unit of dedicated electronics, a computer, or also a hybrid system of these three possibilities. The calculation unit 130 is configured to recover the first and the second measurement signals supplied by the optical detector 120 and to determine the measured absorbed-dose values on the basis of said measurement signals by implementing an optical method for measuring absorbed dose according to the invention.

It will be noted that in this embodiment, the calculation unit 130 is also adapted to control the first and second optical sources 111, 112 and thus manage the illumination of the radiochromic material successively by the first and the second electromagnetic measurement emission within the scope of the dosimetric measurement. Of course, it is also possible, without departing from the scope of the invention, that the first and second optical sources 111, 112 are independent of the calculation unit.

Thus, such an optical measurement 100 may make it possible to implement such a measurement method that comprises the following steps of:
emitting, by the first optical source 111, the first electromagnetic measurement emission at the first wavelength in the direction of the radiochromic material 151 to be measured,
measuring by the optical detector 120 first measurement signals representative of the part of the first electromagnetic measurement emission not absorbed by the radiochromic material 151 to be measured,
emitting, by the second optical source 112, the second electromagnetic measurement emission at the second wavelength in the direction of the radiochromic material 151 to be measured,
measuring by the optical detector 120 second measurement signals representative of the part of the second electromagnetic measurement emission not absorbed by the radiochromic material 151 to be measured,
determining at least one measured absorbed-dose value in the radiochromic material 151 to be measured,

During the step of determining at least one measured absorbed-dose value, the following sub-steps are provided of:
for the or each measured absorbed-dose value to be determined, checking at least one condition from:
   the first measurement signal associated with said measured absorbed-dose value to be determined corresponds to an absorption of the first electromagnetic measurement emission higher than or equal to, or even strictly higher than, a first threshold; and
   the second measurement signal associated with said measured absorbed-dose value to be determined corresponds to an absorption of the second electromagnetic measurement emission higher than or equal to, or even strictly higher than, a second given threshold equivalent to said first threshold,
for the or each measured absorbed-dose value to be determined, in the case where said at least one condition is met, determining said measured absorbed-dose value on the basis of the second measurement signal, said measured absorbed-dose value being determined on the basis of the first measurement signal in the case where said at least one condition is not met.

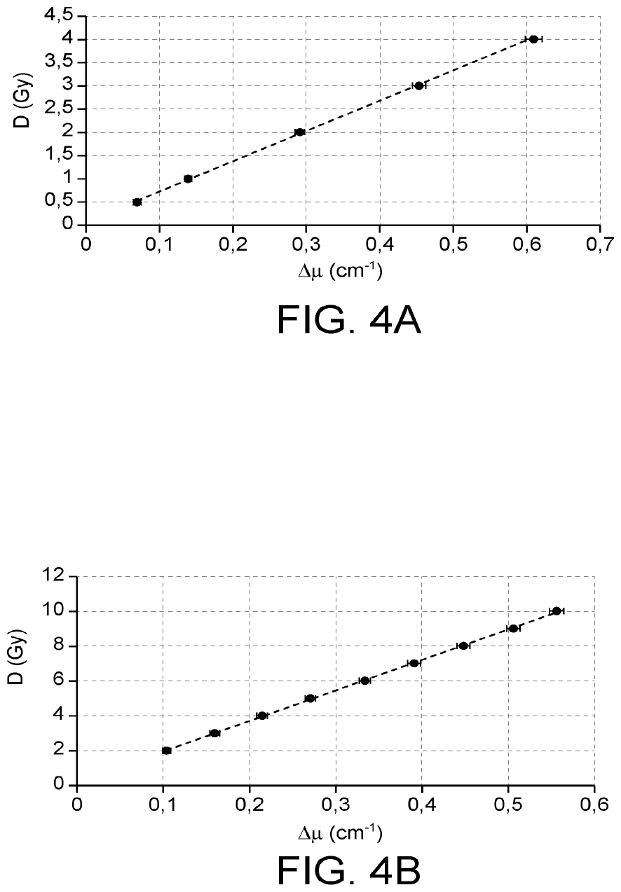

It will be noted that within the scope of determining the or each measured absorbed-dose value, determining the measured absorbed-dose value on the basis of the first measurement signal or on the basis of the second measurement signal may be performed on the basis of a determination relation connecting said first or second measurement signal and the measured absorbed-dose value, such as described hereinafter in connection with FIGS. 4A and 4B.

This optical method for measuring absorbed dose makes it possible, on the basis of various determined absorbed-dose values to reconstitute a mapping of the absorbed dose in the radiochromic material 151, such as a 3D mapping when the optical measurement device 100 implements an optical tomography measurement.

It will be noted that within the scope of such an optical method for measuring absorbed dose, particularly within the scope of developing the optical measurement device 100, a preliminary step of determining the second wavelength may be provided during which the following sub-steps are implemented:
defining a maximum expected absorbed-dose value, in the case of the present embodiment 10 Gy, of a minimum absorbed-dose value to be discriminated, in the case of the present embodiment 0.5 Gy (0.25 Gy also being possible without departing from the scope of the invention), and of the first wavelength, in the case of this first embodiment 590 nm, the first wavelength being associated with an absorption peak of the radiochromic material to be measured after irradiation, in the present embodiment at 585 nm,
supplying at least one first etalon having areas representative of the expected absorption of the radiochromic material for a plurality of respective doses absorbed in a range of absorbed doses ranging from at least the minimum value to be discriminated to at least the maximum expected value,
measuring, for each area of the at least one first etalon, absorption spectra over a range of wavelengths including the absorption peak of the radiochromic material to be measured after irradiation with which the first wavelength is associated,
on the basis of the absorption spectra measured, identifying for the area corresponding to the dose value higher than or equal to the expected maximum dose value, the second wavelength for which the absorption is discriminable with the optical detector,
on the basis of the absorption spectra measured and the areas of the at least one etalon, identifying a transition ionising radiation dose value between the first and the second wavelength for determining the absorbed-dose value to be measured,
defining, on the basis of the transition absorbed-dose value identified and possibly the absorption spectra measured, a threshold from a first threshold corresponding to an absorption of the first electromagnetic measurement emission at said transition absorbed-dose value identified, and a second threshold corresponding to an absorption of the second electromagnetic measurement emission at said transition absorbed-dose value identified.

It will be noted that, within the scope of FIG. 3, supplying the at least one first etalon was obtained by irradiating a plurality of spectrophotometric containers of Fricke-Xylenol orange-Gelatin with absorbed doses ranging from 0.5 Gy to 10 Gy. Thus, according to this possibility, each of the containers is associated with an area corresponding to the absorbed dose of said container. Alternatively, it is also possible, that the at least one etalon is supplied by means of one or more first etalons, having a plurality of irradiated areas spatially separated from one another and each having a respective absorbed dose different from those of the other areas. Of course, this concerns two examples of supplying such an at least one first etalon and other possibilities of supplying at least one first etalon are possible, such as purchasing commercial etalons or irradiating one or more vials in order to obtain in said vial spatial gradients of absorbed doses.

The sub-step of identifying the transition absorbed-dose value may be performed on the basis of an estimation of the expected sensitivity for the optical detector 120 at the first wavelength and at the second wavelength for a given absorption rate. Thus, it is possible to determine, for a given absorbed dose, the wavelength from the first and the second wavelength making it possible to obtain the best sensitivity and to identify said transition absorbed-dose value on this basis.

FIG. 3 illustrates the absorption spectra that may be obtained during the implementation of such a preliminary step of determining the second wavelength. Thus, FIG. 3 illustrates the absorption spectrum (or more specifically the decimal logarithm of the absorption) of the Fricke-Xylenol orange-Gelatin depending on the wavelength of the electromagnetic emission, this for an absorbed dose received by the Fricke-Xylenol orange-Gelatin ranging from 0 Gy to 10 Gy (the values retained being: 0 Gy; 0.5 Gy; 1 Gy; 2 Gy; 3 Gy; 4 Gy; 5 Gy; 6 Gy; 7 Gy; 8 Gy; 9 Gy and 10 Gy). It is easy to identify on these absorption spectra the absorption peak of the Xylenol orange-Fer(III) at 585 nm. It is also observed that for the wavelengths greater than 590 nm, the absorption rate rapidly reduces with the increase of the wavelength. It is thus easy to determine, depending on the maximum expected value, a second suitable wavelength, here 633 nm for a maximum expected dose of 10 Gy.

In the same way, this step of determining the second wavelength also makes it possible to define the first threshold and/or the second threshold. This determination may be performed on the basis of absorption measurements, such as those illustrated by the absorption spectra of FIG. 3 and taking into account the configuration of the first and second optical sources 111, 112 and of the optical detector 120 (particularly its sensitivity). Thus, the inventors identified that the first threshold and/or the second threshold may be selected as corresponding to an absorption of the first and/or of the second electromagnetic measurement emission, corresponding to the first and/or second wavelength, obtained at an absorbed dose between 2.5 and 4.5 Gy, preferably between 3 and 4 Gy. Thus, they have selected a threshold corresponding to a dose of 4 Gy which corresponds, as will be specified in connection with FIGS. 4A and 4B, to an attenuation coefficient of 0.6 cm⁻¹ at the first wavelength, as first threshold, and to an attenuation coefficient of 0.22 cm⁻¹ at the second wavelength as second threshold.

Within the scope of developing the invention, the inventors also identified the determination relations to be used to determine the absorbed dose in the radiochromic material 151 to be measured, as is shown in FIGS. 4A and 4B. Such an identification may be provided concomitantly with the step of determining the second wavelength, that is to say developing the measurement device 100, or during a calibration step performed prior to the step of emitting the first electromagnetic emission (this calibration step being able, for example, to be performed before each dosimetric measurement).

Such an identification may comprise the following sub-steps of:
supplying at least one second etalon, identical to or different from the at least one first etalon, having areas representative of the expected absorption of the radiochromic material for a plurality of doses absorbed in a range of absorbed doses including an absorbed dose corresponding to the first or second threshold,
emitting, by the first optical source 111, a first calibration electromagnetic emission at the first wavelength in the direction of the at least one second etalon,
measuring, by the optical detector 120 and for at least two areas of the at least one second etalon corresponding to two different absorbed doses lower than or equal to the absorbed dose corresponding to the first or second threshold, first calibration signals representative of the part of the first calibration electromagnetic emission not absorbed by the at least one second etalon,
calculating, on the basis of the first calibration signals and for the first wavelength, a first determination relation to be used to determine the measured absorbed-dose value in said radiochromic material 151 to be measured when the condition is not met,
emitting, by the second optical source 112, a second calibration electromagnetic emission at the second wavelength in the direction of the at least one second etalon,
measuring, by the optical detector 120 and for at least two areas of the at least one second etalon corresponding to two different absorbed doses higher than or equal to the absorbed dose corresponding to the first or second threshold of second calibration signals representative of the part of the second calibration electromagnetic emission not absorbed by the at least one second etalon,
calculating, on the basis of the second calibration signals and for the second wavelength, a second determination relation to be used to determine the measured absorbed-dose value in said radiochromic material 151 to be measured when the condition is met.

Thus, within the scope of such a calibration and as already described for the step of determining the second wavelength, the inventors subjected a plurality of vials of Fricke-Xylenol orange-Gelatin with absorbed doses ranging from 0.5 Gy to 10 Gy (from 0.5 to 4 Gy on the one hand for calibrating the measurement at the first wavelength and from 2 to 10 Gy on the other hand for calibrating the measurement at the second wavelength). Therefore, the observations indicated concerning the at least one first etalon also apply to the at least one second etalon used within the scope of the calibration step. It will be particularly noted the possibility of using a number of second etalons lower than the number of irradiated areas this by providing for in the or each etalon a plurality of spatially separated irradiated areas.

Once the various vials of Fricke-Xylenol orange-Gelatin had been irradiated, the inventors were able to carry out a measurement of the absorption at the first and the second wavelength in order to determine the response of the optical measurement device 100 depending on the dose absorbed by the Fricke-Xylenol orange-Gelatin.

The result of these calibration measurements is shown in FIGS. 4A and 4B and clearly shows that the absorption (here an attenuation coefficient Δμ in cm⁻¹) of the radiochromic material varies linearly with the absorbed dose in the radiochromic material, this for the first wavelength (FIG. 4A), over a range of absorbed doses ranging from 0.5 Gy to 4 Gy and, for the second wavelength, over a range of absorbed doses ranging from 2 Gy to 10 Gy. Thus, it is possible to determine a linear relation of the type D=a_{λ}·Δμ+b_{λ} with D the absorbed dose received by the radiochromic material, Δμ the attenuation coefficient measured with the optical measurement device 100 and a_{λ} and b_{λ} the leading coefficient and the attenuation coefficient originally determined by linear regression.

Thus, with such sub-steps implemented within the scope of the calibration step, it is possible to accurately determine the absorbed dose in the radiochromic material on the basis of the first measurement signals as well as on the basis of the second measurement signals.

It will be noted, that alternatively to such a calibration step, and insofar as the calibration curve of the radiochromic material is known at the first and at the second wavelength, it is possible to use a second etalon corresponding to a single absorbed dose, close to the transition absorbed dose identified and to perform the measurements at the first and second wavelengths in order to have a reference measurement associated with each of the first and of the second wavelength. Thus, with such a measurement with a reference absorbed dose common to the first and second wavelength, it is possible to correct any absorbance offsets that may result from a variation of the composition of the radiochromic material or a variation of one of the elements of the optical device for measuring absorbed dose 100 (particularly the intensity of the first and second electromagnetic emissions emitted by the first and second optical sources 111, 112).

In order to demonstrate the correct operation of the optical device for measuring absorbed dose 100 according to the invention, the inventors implemented optimal dosimetric measurements on a vial of radiochromic material having been subjected to a radiotherapy treatment at a dose of 9 Gy, a first time on the basis of a first electromagnetic measurement emission at the first wavelength (therefore 590 nm); a second time on the basis of a second electromagnetic measurement emission at the second wavelength (therefore 633 nm) and, a third time, within the scope of a dosimetric measurement according to the principle of the invention, by combining the measurements obtained the first and second time.

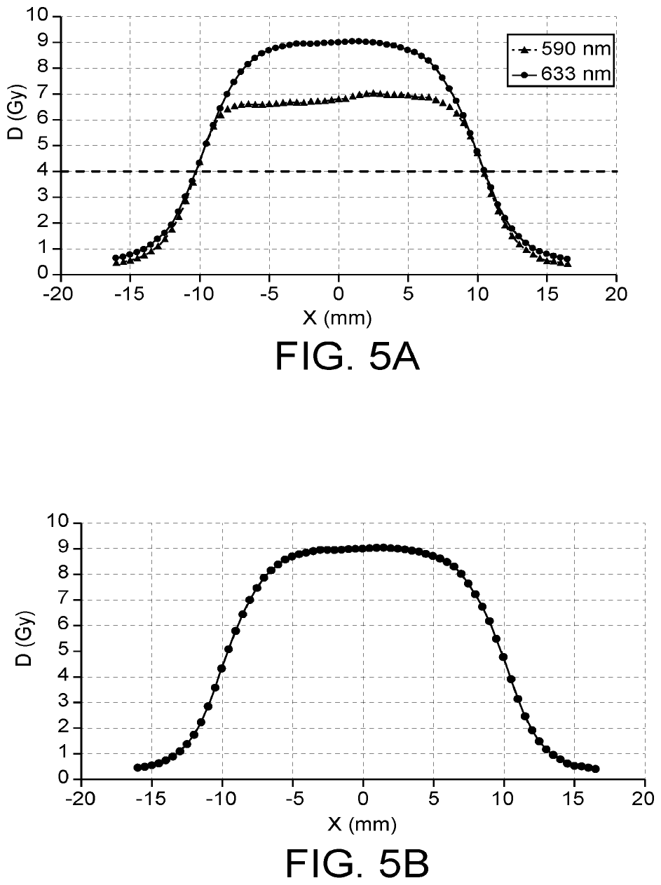

FIG. 5A thus illustrates the variation of the measured absorbed-dose value determined on the basis of respectively the first and the second electromagnetic measurement emission corresponding to the first and the second wavelength. It can be seen that with the first electromagnetic measurement emission, as expected, it is not possible to properly discriminate the absorbed doses higher than 5-6 Gy (even if the estimated absorbed dose rises up to 7 Gy). With the second electromagnetic measurement emission, that is to say that corresponding to the second wavelength, the reverse phenomenon is observed, for the absorbed doses lower than 2-3 Gy, the measured absorbed-dose values are clearly overestimated implying a significant irradiation of the vicinity of the area targeted by the radiotherapy treatment.

FIG. 5B shows the result obtained when, according to the principle of the invention, the optical measurements at the first and at the second wavelength are combined. It is possible to see in this figure that, as expected, the dose absorbed in the area targeted by the radiotherapy treatment is indeed 9 Gy and to identify the part of the irradiation deposited at the vicinity of this targeted area. Thus, this result being obtained with a standard radiochromic material, here Fricke-Xylenol orange-Gelatin, it demonstrates that the method according to the invention makes it possible to solve the problems related to the optical method for measuring absorbed dose of the prior art.

Of course, it will be noted that if within the scope of the present embodiment, a dosimetric measurement is implemented at a first and at a second wavelength, this does not exclude, within the scope of the present invention, the use of a third, or even a fourth wavelength in order to make possible a more sensitive discrimination of the absorbed doses received by the radiochromic material.

1. An optical method for measuring dose absorbed by a radiochromic material to be measured implemented using an optical device for measuring absorbed dose comprising at least one optical source configured to emit an electromagnetic measurement emission and at least one optical detector configured to detect the electromagnetic measurement emission emitted by the at least one optical source, the radiochromic material to be measured having a varying optical absorption depending on the absorbed dose in said radiochromic material and the radiochromic material to be measured having been previously irradiated, the method comprising:
emitting, by the at least one optical source, a first electromagnetic measurement emission at a first wavelength in a direction of the radiochromic material to be measured,
measuring by the at least one optical detector first measurement signals representative of a part of the first electromagnetic measurement emission not absorbed by the radiochromic material to be measured,
determining at least one measured absorbed-dose value in the radiochromic material to be measured,
emitting, by the at least one optical source, a second electromagnetic measurement emission at a second wavelength in the direction of the radiochromic material to be measured, the second wavelength being selected to have, for a given absorbed dose, an absorption rate of the radiochromic material to be measured lower than an absorption rate of the radiochromic material to be measured at the first wavelength, and
measuring by the at least one optical detector second measurement signals representative of a part of the second electromagnetic measurement emission not absorbed by the radiochromic material to be measured,
wherein, the step of determining at least one measured absorbed-dose value comprises:
for the or each measured absorbed-dose value to be determined, checking at least one condition from:
one of the first measurement signals associated with the measured absorbed-dose value to be determined corresponds to an absorption of the first electromagnetic measurement emission higher than or equal to a first threshold; and
one of the second measurement signals associated with the measured absorbed-dose value to be determined corresponds to an absorption of the second electromagnetic measurement emission higher than or equal to a second threshold equivalent to the first threshold, and
for the or each measured absorbed-dose value to be determined, in a case where the at least one condition is met, determining the measured absorbed-dose value on a basis of the one second measurement signal, the measured absorbed-dose value being determined on a basis of the one first measurement signal in the case where the at least one condition is not met.

2. The measurement method according to claim 1, wherein the at least one optical source comprises a first optical source configured to emit the first electromagnetic measurement emission and a second optical source configured to emit the second electromagnetic measurement emission, the first optical source being implemented during emitting the first electromagnetic measurement emission and the second optical source being implemented during emitting the second electromagnetic measurement emission.

3. The measurement method according to claim 1, wherein the first wavelength is associated with an absorption peak of the irradiated radiochromic material, and wherein the second wavelength is selected in such a way that, for a given absorbed dose, the radiochromic material has at the second wavelength an absorption rate lower than two times the absorption rate presented at the first wavelength.

4. The measurement method according to claim 1, wherein the radiochromic material is a dosimetric gel comprising xylenol orange, the first wavelength being between a first range of wavelengths ranging from 550 to 600 nm and the second wavelength being in a second range of wavelengths ranging from 620 to 645 nm.

5. The method according to claim 4, wherein the first threshold and/or the second threshold corresponds to an absorption of the first and/or second electromagnetic measurement emission obtained for an absorbed dose between 2.5 Gy and 4.5 Gy.

6. The measurement method according to claim 1 comprising a preliminary step of determining the second wavelength comprising:
defining a maximum expected absorbed-dose value, a minimum value to be discriminated of absorbed dose and of the first wavelength, the first wavelength being associated with an absorption peak of the radiochromic material to be measured after irradiation,
supplying at least one first etalon having areas representative of expected absorption of the radiochromic material for a plurality of respective doses absorbed in a range of absorbed doses ranging from at least the minimum value to be discriminated to at least the maximum expected value,
measuring, for each area of the at least one first etalon, absorption spectra over a range of wavelengths including the absorption peak of the radiochromic material to be measured after irradiation with which the first wavelength is associated,
on a basis of the absorption spectra measured, identifying for an area corresponding to a dose value higher than or equal to the maximum dose value, the second wavelength for which the absorption is discriminable with the optical detector,
on the basis of the absorption spectra measured and the areas of the at least one etalon, identifying a transition absorbed-dose value between the first and the second wavelength for determining the absorbed-dose value to be measured, and
defining, on a basis of the transition absorbed-dose value identified and the absorption spectra measured, a threshold from a first threshold corresponding to an absorption of the first electromagnetic measurement emission at the transition absorbed-dose value identified, and a second threshold corresponding to an absorption of the second electromagnetic measurement emission at the transition absorbed-dose value identified.

7. The method according to claim 1, further comprising a preliminary calibration step, the preliminary calibration step comprising:
supplying at least one second etalon having areas representative of expected absorption of the radiochromic material for a plurality of doses absorbed in a range of absorbed doses including an absorbed dose corresponding to the first or second threshold,
emitting, by the at least one optical source, a first calibration electromagnetic emission at the first wavelength in a direction of the at least one second etalon,
measuring, by the optical detector and for at least two areas of the at least one second etalon corresponding to two different absorbed doses lower than or equal to the absorbed dose corresponding to the first or second threshold, first calibration signals representative of a part of the first calibration electromagnetic emission not absorbed by the at least one second etalon,
calculating, on a basis of the first calibration signals and for the first wavelength, a first determination relation to be used to determine the measured absorbed-dose value in said radiochromic material to be measured when the condition is not met,
emitting, by the at least one optical source, a second calibration electromagnetic emission at the second wavelength in the direction of the at least one second etalon,
measuring, by the optical detector and for at least two areas of the at least one second etalon corresponding to two different absorbed doses higher than or equal to the absorbed dose corresponding to the first or second threshold, second calibration signals representative of the part of the second calibration electromagnetic emission not absorbed by the at least one second etalon, and
calculating, on a basis of the second calibration signals and for the second wavelength, a second determination relation to be used to determine the measured absorbed-dose value in said radiochromic material to be measured when the at least one condition is met.

8. An optical device for measuring absorbed dose of a radiochromic material to be measured, the radiochromic material to be measured having a varying optical absorption depending on the absorbed dose, comprising:
at least one optical source configured to emit a first electromagnetic measurement emission at a first wavelength in a direction of the radiochromic material to be measured,
at least one optical detector configured to detect the first electromagnetic measurement emission emitted by the at least one optical source and configured to measure the first measurement signals representative of a part of the first electromagnetic measurement emission not absorbed by the radiochromic material to be measured, and
a calculation unit configured to determine at least one measured absorbed-dose value in the radiochromic material to be measured,
wherein:
the at least one optical source is configured to emit a second electromagnetic measurement emission at a second wavelength, the second wavelength having, for a same given absorbed dose, an absorption rate of the radiochromic material to be measured lower than an absorption rate of the radiochromic material at the first wavelength,
the at least one optical detector is configured to measure second measurement signals representative of a part of the second electromagnetic measurement emission not absorbed by the radiochromic material to be measured,
the calculation unit is configured to, during the determination of the at least one measured absorbed-dose value:
for the or each measured absorbed-dose value to be determined, check at least one condition from:
one of the first measurement signals associated with said absorbed dose corresponds to an absorption of the first electromagnetic measurement emission higher than or equal to a first threshold; and
one of the second measurement signals associated the said absorbed dose corresponds to an absorption of the second electromagnetic measurement emission higher than or equal to a second threshold equivalent to the first threshold;
for the or each measured absorbed-dose value to be determined, in a case where the at least one condition is met, determine the measured absorbed-dose value on a basis of the one second measurement signal, the calculation unit determining the measured absorbed-dose value on a basis of the one first measurement signal in a case where the at least one condition is not met.

9. The optical device for measuring absorbed dose according to claim 8, wherein the at least one optical source comprises a first optical source configured to emit the first electromagnetic measurement emission and a second optical source configured to emit the second electromagnetic measurement emission.

10. The optical device for measuring absorbed dose according to claim 8, wherein the radiochromic material to be measured is a dosimetric gel comprising xylenol orange, the first wavelength being in a first range of wavelengths ranging from 550 to 600 nm and the second wavelength being in a second range of wavelengths ranging from 620 to 645 nm.

11. The method according to claim 1, wherein
the one of the first measurement signals associated with the measured absorbed-dose value to be determined corresponds to an absorption of the first electromagnetic measurement emission strictly higher than the first threshold; and
the one of the second measurement signals associated with the measured absorbed-dose value to be determined corresponds to an absorption of the second electromagnetic measurement emission strictly higher than the second threshold.

12. The measurement method according to claim 1, wherein the first wavelength is associated with an absorption peak of the irradiated radiochromic material, and wherein the second wavelength is selected in such a way that, for a given absorbed dose, the radiochromic material has at the second wavelength an absorption rate lower than four times the absorption rate presented at the first wavelength.

13. The measurement method according to claim 1, wherein the radiochromic material is a dosimetric gel comprising xylenol orange, the first wavelength being between a first range of wavelengths ranging from 570 to 590 nm, and the second wavelength being in a second range of wavelengths ranging from 625 to 640 nm.

14. The method according to claim 4, wherein the first threshold and/or the second threshold corresponds to an absorption of the first and/or second electromagnetic measurement emission obtained for an absorbed dose between 3 Gy and 4 Gy.

15. The optical device for measuring absorbed dose according to claim 8,
the one of the first measurement signals associated with the absorbed dose corresponds to an absorption of the first electromagnetic measurement emission strictly higher than the first threshold; and
the one of the second measurement signals associated the absorbed dose corresponds to an absorption of the second electromagnetic measurement emission strictly higher than the second threshold.

16. The optical device for measuring absorbed dose according to claim 8, wherein the radiochromic material to be measured is a dosimetric gel comprising xylenol orange, the first wavelength being in a first range of wavelengths ranging from 570 to 590 nm, and the second wavelength being in a second range of wavelengths ranging from 625 to 640 nm.
